(19) United States
(12) Patent Application Publication
(10) Pub. No.: US 2026/0214162 A1
(43) Pub. Date: Jul. 23, 2026

(54) VOICE PHISHING DETECTION AND MITIGATION

(71) Applicant: T-Mobile USA, Inc., Bellevue, WA (US)

(72) Inventor: Gaviphat Lekutai, Kirkland, WA (US)

(21) Appl. No.: 19/031,124

(22) Filed: Jan. 17, 2025

(51) Int. Cl. H04M 3/22; H04M 1/72484; H04M 3/42; H04W 8/18; H04W 12/128

(52) U.S. Cl. CPC H04M 3/2281; H04M 1/72484; H04M 3/42042; H04W 8/18; H04W 12/128

(57) ABSTRACT

Voice vishing (vishing) is a type of scam where fraudsters use phone calls to steal sensitive information or money, often by spoofing phone numbers to appear legitimate. Some implementations described herein utilize source identification signals to help disrupt vishing. These signals can verify the legitimacy of a call, making it harder for scammers to succeed. Source identification signals can be signals embedded in a call and can be verified by wireless telecommunicates providers, user devices, or other entities. In some implementations, dynamically generated signals are based on factors such as the recipient's phone number and time, making it significantly more difficult for scammers to replicate source identification signals. In some implementations, transmission properties such as band, channel, or time slot are used in verification processes.

### BACKGROUND

Voice phishing (vishing) is a form of social engineering attack where an attacker uses voice calls to deceive individuals into revealing sensitive information or performing certain actions. Vishing can utilize conventional landline networks, cellular networks, Voice over Internet Protocol (VoIP), etc. Vishing often involves impersonating a trusted entity, such as a bank representative, government official, or family member, to manipulate victims into providing personal information, passwords, financial information, and so forth. Vishing attacks can employ automated voice messages or interactive voice response system to trick individuals into taking specific actions, such as transferring funds (e.g., directly from bank accounts, using a money transfer application, or via gift cards) or disclosing confidential information.

### BRIEF DESCRIPTION OF THE DRAWINGS

Detailed descriptions of implementations of the present invention will be described and explained through the use of the accompanying drawings.

FIG. 1 is a block diagram that illustrates a wireless telecommunication network in which aspects of the disclosed technology are incorporated.

FIG. 2 is a block diagram that illustrates an architecture including 5G core network functions (NFs) that can implement aspects of the present technology.

FIG. 3 is a flowchart that illustrates an example signal-based vishing detection and notification process according to some implementations.

FIG. 4 is a flowchart that illustrates an example process for on-device call verification according to some implementations.

FIG. 5 is a flowchart that illustrates another example process for call verification according to some implementations.

FIG. 6 is a flowchart that illustrates another example process for call verification according to some implementations.

FIG. 7 is a flowchart that illustrates another example process for call verification according to some implementations.

FIG. 8 is a flowchart that illustrates an example call verification process according to some implementations.

FIG. 9 is a flowchart that illustrates another example call verification process according to some implementations.

FIGS. 10A and 10B are drawings that illustrate example alerts that can be displayed on a device according to some implementations.

FIG. 11 is a block diagram that illustrates an example of a computer system 1100 in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Vishing (voice phishing) is a type of social engineering scam in which scammers attempt to obtain sensitive information or extract money from individuals over the phone. Scammers have become increasingly sophisticated in their vishing efforts, often using various techniques to hide their real identity and appear as legitimate callers. For example, scammers may spoof their phone number in an effort to appear more legitimate. Recent technological advancements have greatly improved the potential quality of vishing scams, making them more convincing and harder to identify. For example, scammers can use large language models to generate scripts that are grammatically correct and sound legitimate. Realistic text to speech (TTS) models can be used to make the scammer sound more legitimate. For example, a scammer may use a TTS model to generate speech with a particular accent, tone of voice, and so forth. In some cases, scammers may even use TTS technologies to impersonate specific individuals, such as a potential victim's family member.

Vishing scams typically follow a pattern. For example, scammers utilize caller identification spoofing to mask their phone number, making it appear as if they are calling from a legitimate entity or at least calling from an area the recipient would expect to receive a call from (e.g., a number within their city or state, or a number within their country). Scammers may appear to be calling from a bank, government agency, utility company, family member, etc. For example, one common scam is to call foreign nationals posing as someone from the consulate, and the call can appear to be from the consulate that services the region where the recipient is located (e.g., a Chinese national living in New York may receive a call that appears to be from the Chinese consulate in New York). Another is to call pretending to be a relative who has been arrested and is in need of money to get out of jail. These sorts of scams can be especially nefarious as they often take advantage of fear as well as the recipient's lack of familiarity with expected procedures, relevant laws, and so forth. Scammers may also attempt to create a sense of urgency by telling a caller that fraudulent charges have been detected, their accounts have been frozen, and so forth. Some other examples of common vishing scams include tech support scams, in which scammers manipulate victims into giving the scammer control of their computer and then demand payment to fix non-existent problems or otherwise trick victims into giving them money, lottery or prize scams, where victims are asked to provide payment to cover taxes or processing fees before a prize can be awarded, charity scams, in which scammers try to trick people into making donations to fake charities, utility company scams, in which scammers demand payment to prevent utility service from being disconnected, and work from home scams, in which scammers offer work-from-home jobs and demand personal information, upfront fees, and so forth.

The scammer can attempt to extract money or other useful information from the recipient. For example, a scammer may try to obtain credit card numbers, social security numbers, bank account numbers, passwords, gift card information, and so forth. Once someone becomes a victim, the scammer may continue trying to extract more money from them, for example by prolonging the scam with additional demands or by targeting the victim with additional scams.

Scammers often use intimidation tactics to coerce the recipient into complying with their demands. For example, a scammer may threaten legal action, financial loss, arrest, deportation, etc., if the recipient does not comply. In some cases, a scammer may attempt to use emotional appeals such as flattery or sympathy to gain the recipient's trust. In some cases, scammers may use confusing language to overwhelm the recipient and make it difficult for the recipient to understand what is happening. This can be especially successful when scammers call about things that the recipient may have limited familiarity with, such as criminal arrests, immigration matters, overseas medical emergencies, and so forth. Moreover, scammers may utilize publicly available data to appear more convincing, for example by using the names of relatives, mentioning previous cities where a call recipient has lived, and so forth.

While vishing is often used to extract money from individual victims, vishing efforts can extend far beyond this. For example, vishing can be used to try to extract sensitive information from companies, such as financial information, login credentials, business secrets, and so forth. As an example, someone posing as an IT professional at a company can dupe an employee into providing login credentials that can be used as part of a larger attack against the company, or a scammer may attempt to get account and routing numbers from a company.

Given the prevalence of vishing scams and the potential consequences of falling victim to a vishing scam, there is a need for approaches that can limit the impact of vishing and prevent individuals from falling victim to vishing scams. User education can help to some degree, for example by teaching individuals about common scams, signs to look out for, and ways to protect yourself (e.g., by hanging up and calling the number on the back of an individual's credit card rather than divulging information to the caller), but there can still be many cases where individuals fall victim to vishing scams. Moreover, as described herein, vishing scams are increasingly sophisticated and convincing, making them difficult for even vigilant individuals to spot.

Wireless telecommunications companies have made significant efforts to identify scam calls and to alert users when they receive such calls. However, these techniques have largely been reactive and tend to rely on identifying fraudulent calls rather than verifying calls as coming from a legitimate source. In some cases, callers may only be identified as likely scammers after a large number of calls have been made. In some cases, telecommunications companies utilize statistical or machine learning models to identify likely scammers. For example, a machine learning model can be trained on historical call records that contain information such as origin, destination, duration, whether or not the call was answered or sent to voicemail, and so forth. Using such models, a telecommunications company can predict when calls are likely to be from scammers. For example, if a number suddenly starts calling many different numbers, suddenly starts placing a large volume of calls at the same time of day, frequently places unanswered calls, or leaves voicemails that have a consistent length, this can indicate that the caller may be a scammer. Scam numbers can be added to a database, which can be used to alert users when they are receiving a call from a likely scammer (e.g., by displaying a notification such as “Scam Likely” on the user's phone).

Another approach some companies use it to utilize a side channel for verification and/or authentication. For example, a bank might send a push notification to a client that asks the client to utilize their banking application for verification. In some cases, less secure methods such as sending a text message with a one time code are utilized. However, such approaches add complexity and are not widely or consistently used, and thus provide limited benefit. Moreover, scammers may utilize such features, which are more commonly used to verify a caller when they call a company such as a bank than to verify that a call actually originates from a company, to make a scam call appear more legitimate, for example by texting a code to a call recipient to lend an appearance of legitimacy.

While existing approaches can be somewhat effective, it can still be difficult to identify scammers. For example, scammers can easily use different phone numbers. Additionally, since scammers often spoof their phone numbers, blocking numbers used by scammers can result in legitimate calls also being blocked. Continuing with the consulate example, blocking the number would not be a viable solution as this would also block legitimate calls from the consulate.

Accordingly there is a need for improved approaches to identifying scam calls and preventing individuals from falling victim to scammers. Described herein are approaches that can be used to verify that a call originates from a known legitimate source. The techniques herein can be applied to voice calls, video calls, calls via wired or wireless telephone networks, calls using voice over IP, or any other calling type or method. Recipients can be alerted when a call comes from a verified source and/or when a call cannot be verified (and thus may be from a scammer). Advantageously, the approaches herein do not rely on phone numbers or other information that can be easily spoofed.

In some implementations, the approaches herein utilize a source identification signal to determine whether or not a call is legitimate. The source identification signal can be an audio signal, data signal, or any other type of signal that can be used to verify the source of the call. In some implementations, verification is performed by a wireless telecommunications provider. In some implementations, verification is performed by user equipment such as a smartphone. A combination of verification by the wireless telecommunications provider and the user equipment can be used. For example, the wireless telecommunications provider may be a primary means of verifying calls, while on-device verification is used as a fallback method, for example when the user equipment is roaming on another network or the wireless telecommunications provider is otherwise unable to perform verification tasks. Other verification approaches can be utilized additionally or alternatively, such as transmitting verified calls over particular channels, frequencies, bands, time slots, etc., as described herein.

In some implementations, a wireless telecommunications service (e.g., a cellular network or non-terrestrial network such as a satellite network) generates a source identification signal that is transmitted to user equipment (e.g., to a smartphone). The source identification signal can indicate that a call originates from a trusted source. A user's device can display a visual alert, provide an audible notification, or otherwise inform the user when a call appears not to originate from a verified source. In some implementations, a user's device displays an alert or otherwise provides a notification to the user when a call originates from a verified source. In some implementations, any of various mitigation actions can be taken when a call cannot be verified, such as providing a notification or dropping the call. The source identification signal can, additionally or alternatively, be generated by a caller. For example, a company such as a bank can send a source identification signal to a call recipient as part of the call when it places a call to a customer.

A source identification signal can be encoded as part of a data stream, as part of the call (e.g., as part of the call audio), etc. For example, in some implementations, a source identification signal is added as an audio signal, such as a beep or series of beeps or tones. In some implementations, the audio signal is outside the range of human hearing, such that the call recipient does not hear the source identification signal. For example, an audio signal made up of frequencies that are less than about 20 Hz and/or more than about 20 kHz typically will not be heard by humans. In some implementations, software installed on the user's device processes the source identification signal to determine if the call originated from a verified source. Such functionality can be implemented, additionally or alternatively, in the hardware of the user's device. In the case of software, the software can be a separate application (e.g., a custom dialer application) or can be built into the operating system or be part of the base application set of a user device.

While an inaudible source identification signal can be used in some cases, in some implementations, the audio signal can be heard by the recipient. For example, the audio signal can be included as part of an audible tone, jingle, etc., that can be heard by the recipient. The recipient may or may not be aware that the audio signal is used for verification purposes.

In some implementations, a caller's device (e.g., a company-assigned handset or soft phone) or any other part of a company's telephony stack is configured to encode the source identification signal that is sent to the user's device. In some implementations, encoders, decoders, or both are implemented in hardware. In other implementations, encoders, decoders, or both are implemented in software. For example, a bank, phone company, utility provider, etc., can integrate source identification signal generating into their telephony systems such that outgoing calls include the source identification signal, which can be generated by the company.

An embedded source identification signal can take on a wide variety of forms. For example, an embedded source identification signal can have a specified frequency or set of frequencies. The source identification signal can include a single tone or multiple tones, can have a fixed or variable amplitude, can repeat or not, can repeat at a particular rate or according to a particular pattern, etc. In some implementations, a source identification signal is specific to a particular caller (e.g., to a specific company) and does not change over time or changes relatively infrequently, such that the same source identification signal is used for multiple calls to the same recipient and/or to different recipients. Source identification signals can be, additionally or alternatively, non-audio data, or wireless transmission configuration information (e.g., channel, band, time slot).

While simple source verifications signals can provide some protection against scam callers, such signals may be easy for scammers to copy once they become aware that source identification signals are being used for caller verification. In some implementations, a more complex source identification signal is generated using, for example, a set of equations, formulas, or algorithms. This can provide improved protection, but scammers may still be able to duplicate source identification signals depending upon the complexity, inputs, and so forth of the equations, formulas, or algorithms. In some implementations, source identification signals are dynamically generated. For example, a source identification signal can be generated using an algorithm that utilizes information such as the recipient's phone number (or a subset of the recipient's phone number), the current date, day of the week, time of day, month, year, etc. In some implementations, a source identification signal is generated based at least in part on the recipients phone number or a part of the recipient's phone number (e.g., last digit, last three digits, last four digits, area code, etc.). This can make it significantly more difficult for a scammer to replicate the correct signals. For example, if the same source identification signal is used for all recipients, then once a scammer obtains a source identification signal, it can be used to place a “verified” call to any recipient. By considering the last two digits of the phone number when generating the source identification signal, the number of source identification signals a scammer would need to determine and copy rises from one to one hundred. As more inputs are used to generate source identification signals, it can become increasingly difficult for scammers to successfully what the possible valid source identification signals are and the circumstances under which different source identification signals should be used.

In some implementations, other complications can be used additionally or alternatively to make it more difficult for scammers to generate correct source identification signals. For example, source identification signals can change on a regular basis (e.g., hourly, daily, weekly, monthly), and so forth. By adding complexity and/or recipient-specificity to the generation process, it can be difficult or even effectively impossible for scammers to replicate valid signals.

The approaches described above can provide significant protection against vishing scams by verifying the source of a call and notifying the recipient when a call cannot be verified, when a call is verified, or both. The approaches described above do not rely on there being any shared non-public information between the caller and the recipient. Thus, the approaches above can be used even when there is no pre-existing relationship between the caller and the recipient. Often, callers are contacting existing customers (e.g., a wireless telecommunications provider may reach out to its existing customers, or a utility company may place a call to a customer who has missed a payment).

Time-based one-time password (TOTP) is an algorithm that generates one-time passwords (OTPs) using the current time as a source of uniqueness. TOTPs are commonly used as a form of multi-factor authentication by websites and other services and can help protect against unauthorized access even if a user's username and password are compromised. TOTPs operate using a shared secret known to both the client (e.g., an authenticator application) and a server (e.g., a web server). Both the client and server can use the shared secret to compute TOTPs. To authenticate, a user can enter the TOTP generated by the client, and the server can compare the entered TOTP to a TOTP generated by the server using the same shared secret.

The source identification signals described herein can, in some implementations, operate in a similar manner. A user's device can operate as the “server” that receives a source identification signal computed by the caller (the “client”) and compares the source identification signal to a source identification signal computed by the user's device. Such an approach can be specific to particular callers but not to specific recipients or can be specific to particular recipients. The latter case can be more akin to how TOTPs traditionally work, with different TOTPs for different users. In the former case, an entity such as a bank can compute TOTPs that are valid for all recipients, and recipient devices can compute TOTPs using the same shared secret. In some implementations, there are multiple shared secrets, for example, shared secrets for different ranges of phone numbers, which can add increased complexity to the TOTPs and reduce the likelihood that a scammer can determine a TOTP that is valid for multiple users.

In many cases, the use of source identification signals for caller verification can be effective for alerting users to potential scam calls. In some cases, other approaches can be used additionally or alternatively. For example, in the context of a wireless telecommunications network, legitimate calls can be carried over specific cellular bands, frequency bands, channels, timeslots, symbols, etc. This can be particularly powerful because the network operator itself is in control of transmission of the call, and thus a scammer cannot specify how the call is connected to the end user. However, there can be significant limitations. For example, if the call originates from outside the wireless telecommunications network, there is a need to verify the legitimacy of the call before connecting the recipient. Another limitation is that users often utilize Wi-Fi calling when at frequent locations such as at home or at work, in which case the call is transmitted over a Wi-Fi rather than a cellular connection.

Source identification signal verification can occur in various ways. For example, if a source identification signal is sent as a lossless data stream, a received source identification signal can be directly compared to an expected source identification signal computed by the user's device (or by comparing, for example, a hash computed by the user's device) to determine if the source identification signal matches the expected signal. In some implementations, the expected signal can be predetermined and stored on the user's device or accessed by the user's device (e.g., by accessing a server). If a source identification signal is sent as audio and potentially compressed or otherwise modified during transmission, an exact comparison may not be possible or may frequently fail and falsely indicate that a call is a potential scam when it actually originates from a verified source. In some implementations, similarity measurements are used to verify a source identification signal (e.g., an audio signal). In some implementations, partial matching is used for lossless data. In some implementations, a call is considered verified if the similarity between a received source identification signal and an expected signal is above a threshold amount.

For example, a device (e.g., user equipment, a server operated by a carrier, etc.) can resample a received source identification signal and an expected source identification signal (e.g., as computed by the device) to ensure that both the received source identification signal and the expected source identification signal have the same sampling rate. In some implementations, the device normalizes the amplitude of the received source identification signal and the expected source identification signal. The device can trim the received source identification signal, which can, for example, include audio from before and/or after the actual source identification signal. In some implementations, resampling, normalization, and so forth may not be performed on one or more of the source identification signals, as they may already be appropriately sampled, normalized, or both, or such operations may only be performed on one source identification signal (e.g., the received source identification signal).

The device can extract one or more features from the received source identification signal and the expected source identification signal, such as waveforms, spectrograms, Mel-Frequency Cepstral Coefficients, chroma features, and so forth. The device can compare the features using one or more methods, such as cross-correlation to measure the similarity between two waveforms. The extracted features can be encoded into a feature vector, and the device can determine similarity using, for example, Euclidean distance, Manhattan distance, cosine similarity, etc. When a comparison indicates similarity between the expected signal and the actual received signal above a threshold amount, the device can determine that the received signal is correct and the caller is verified. Otherwise, the device can determine that the caller is not verified. In some implementations, multiple thresholds are used. For example, when similarity is above a first threshold, the call can be verified, when the similarity is above a second (lower) threshold but below the first threshold, the call can be undetermined, and when the similarity is below the second threshold, the call can be determined as likely being a scam.

The source identification signals described herein may typically be used by companies such as banks, wireless telecommunications providers, and so forth, though they may also be used more broadly, for example by individuals. In some implementations, source verification as described herein may only be performed when a call appears to originate from a number for which a source identification signal is expected, while calls originating from other numbers are not verified using the approaches described herein. In some implementations, a system (e.g., a device operated by a wireless telecommunications company or a user equipment device such as a smartphone) determines if a signal is expected to be present, for example based on a phone number associated with the call.

Entities that wish to utilize source identification signals can change over time, for example as new companies open, old companies shut down, companies merge or spin off, and so forth. Moreover, entities may add or remove phone numbers over time. Thus, it can be important to ensure that verification processes utilize up to date information about which numbers should be verified. In some implementations, user equipment can be provided with a list or other record of phone numbers that should be verified. The record can be provided, for example, as a text file such as a delimited file (e.g., CSV, TSV), JavaScript Object Notation (JSON) file, YAML file, etc. In some implementations, the record can include phone numbers, associated entities, information for determining expected signals, etc. In some implementations, the associated entity information can be used when displaying verification information. For example, rather than a generic “Caller Verified” message, a user device may display a more specific notification such as “Verified call from ABC Bank.” In some implementations, entity information is not included.

In some implementations, a wireless telecommunications service sends verification information to user equipment. The verification information can include, for example, an indication that the call should be verified, information for verifying the call (e.g., expected source identification signal or information for determining an expected source identification signal). Such an approach can be advantageous over transmitting files with verification information for all numbers that should be verified as only up to date information can be sent, and only information that is relevant for verifying calls received needs to be transmitted, rather than a potentially very large file that includes verification information for all verifiable numbers regardless of whether the user equipment receives call from any given number. However, having a local copy can be advantageous as the verification approaches described herein can continue to work even when user equipment is roaming onto other networks.

### Wireless Communications System

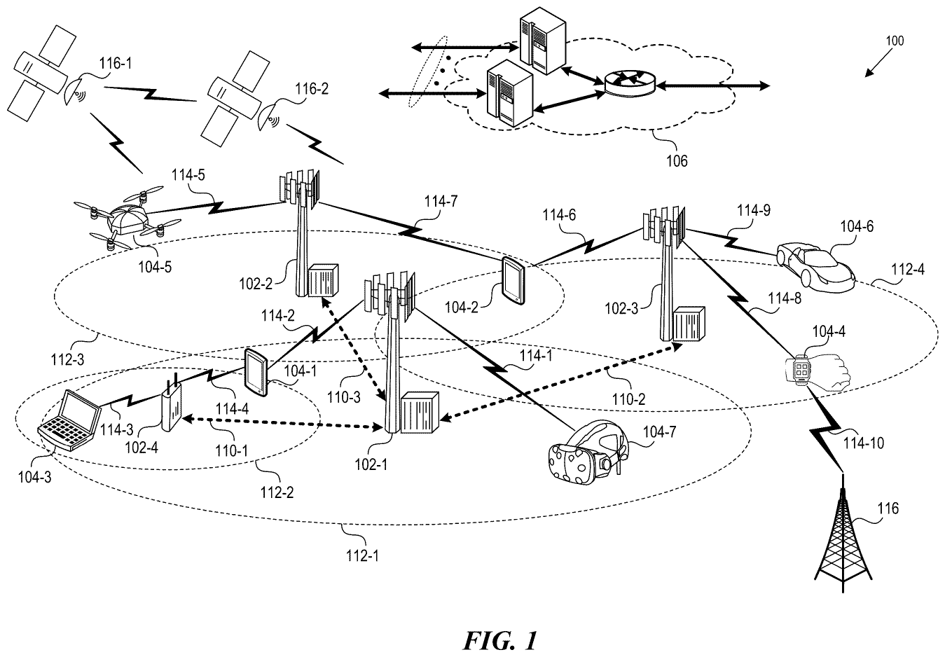

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

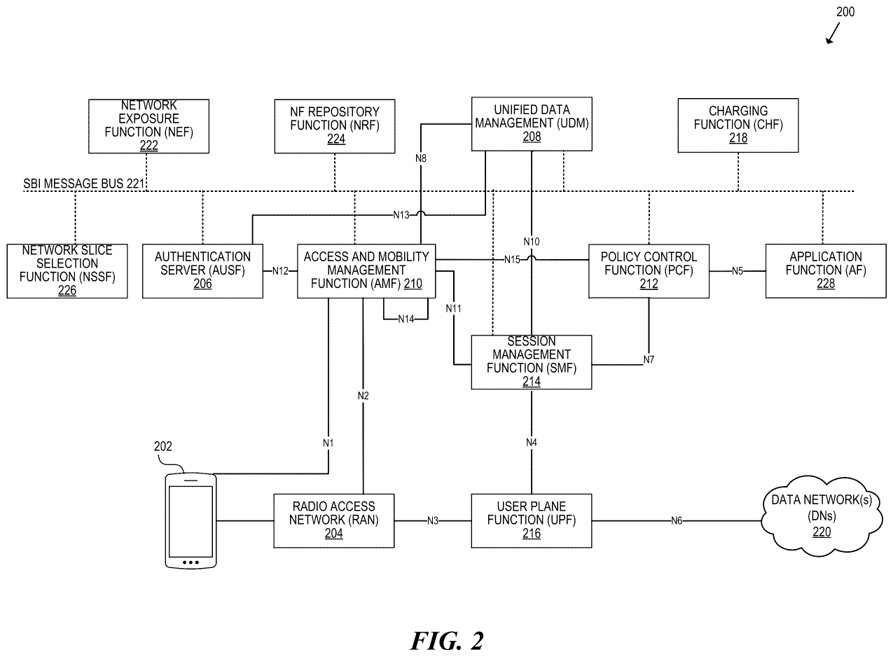

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Implementations

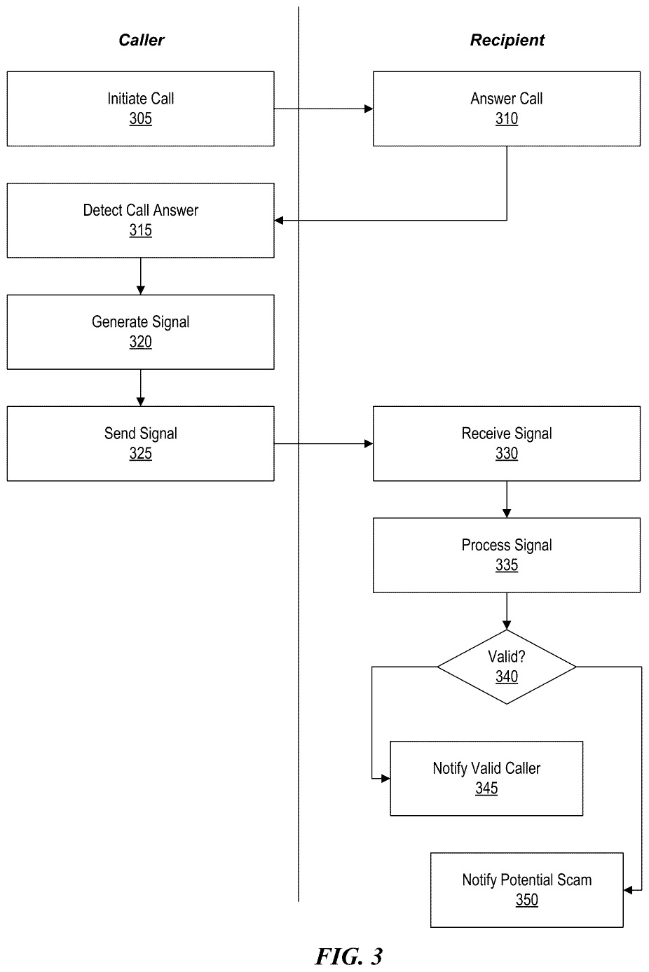

FIG. 3 is a flowchart that illustrates an example signal-based vishing detection and notification process according to some implementations. At operation 305, a caller can initiate a call to a mobile device. At operation 310, a recipient can answer the call on the mobile device. At operation 315, the caller's device (or another component of the network connecting the caller to the recipient) can detect that the call has been answered. At operation 320, the caller device can generate a source identification signal. As described herein, the signal can be a generic signal or can be customized based on time, the phone number of the receiving device, etc. At operation 325, the caller device can send the generated signal to the receiving device. At operation 330, the receiving device can receive the signal. At operation 335, the receiving device can process the signal. At operation 340, based on the analysis, the receiving device can determine if the call originates from a valid source or not. If so, at operation 345, the receiving device can notify the recipient that the caller is verified. If not, the system can, at operation 350, notify the caller that the call is a potential scam.

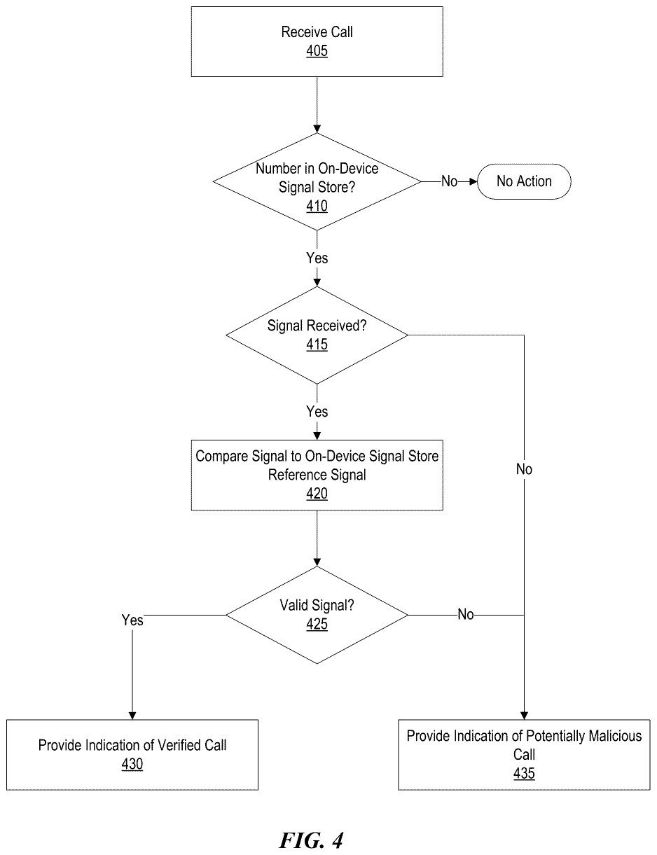

FIG. 4 is a flowchart that illustrates an example process for on-device call verification according to some implementations. At operation 405, a user equipment device (UE) can receive a call. At operation 410, the UE can determine if a number of the call is included in an on-device signal store. If not, the UE may take no further action as the call does not appear to originate from a number that is expected to be verifiable using the approaches described herein. If the number is included in the on-device signal store, the system can, at operation 415, check if a signal was received. If not, the UE can provide an indication to the user at operation 436 indicating that the call is potentially malicious or otherwise could not be verified. If a signal was received, the system can, at operation 420, compare the received signal to a reference signal included in the on-device signal store. In some implementations, the on-device signal store stores expected signals. In some implementations, the on-device signal store stores information that can be used to compute an expected signal (e.g., in the case where signals change over time according to an algorithm). In some implementations, the on-device signal store includes hashes or other representations of expected signals. At operation 425, the UE can determine, based on the comparison, if the received signal is valid or not. If not, the UE can, at operation 435, provide an indication to the user that the call is potentially malicious or otherwise unverified. If the signal is validated at operation 425, the UE can provide an indication to the user that the call is verified at operation 430.

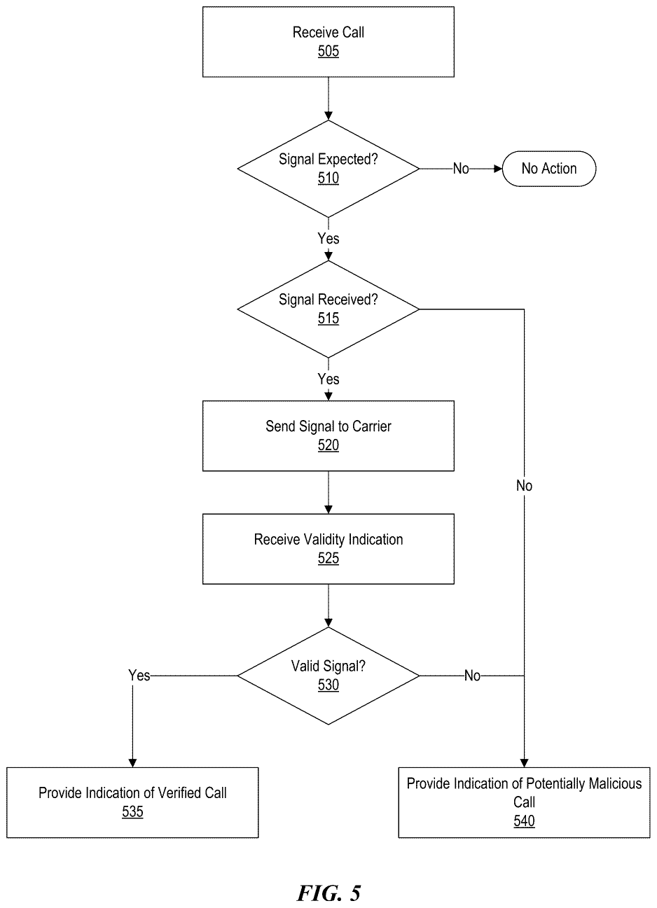

FIG. 5 is a flowchart that illustrates another example process for call verification according to some implementations. In FIG. 5, verification is partially performed by a carrier. At operation 505, a UE can receive a call. At operation 510, the UE can determine if a signal was expected. For example, the UE can check the number against a database of verified numbers stored on the UE or accessible by the UE, or the UE can receive an indication from the carrier that a signal is expected. An on-device cache of verified numbers or an accessible source of verified numbers can be desirable because the verification process can work even when the UE is roaming onto another network. In some implementations, the carrier sends an indication to the UE that the number is expected to originate from a verified source. If no verification is expected, the process can end and no action may be taken.

If a signal is expected, the UE can determine at operation 515 if a signal was received. If not, the UE can provide an indication to a user that the call is potentially malicious or otherwise unverified at operation 540. If a signal was received, the UE can send the signal to the carrier at operation 520. In some implementations, the signal itself is sent. In some implementations, a hash or other representation of the signal is sent to the carrier. At operation 525, the system can receive an indication of validity from the carrier. At operation 530, the UE can determine, based at least in part on the received indication, if the call is verified. If so, the UE can provide an indication to the user that the call is verified at operation 535. If not, the system can provide an indication that the call may be malicious or is otherwise unverified at operation 540.

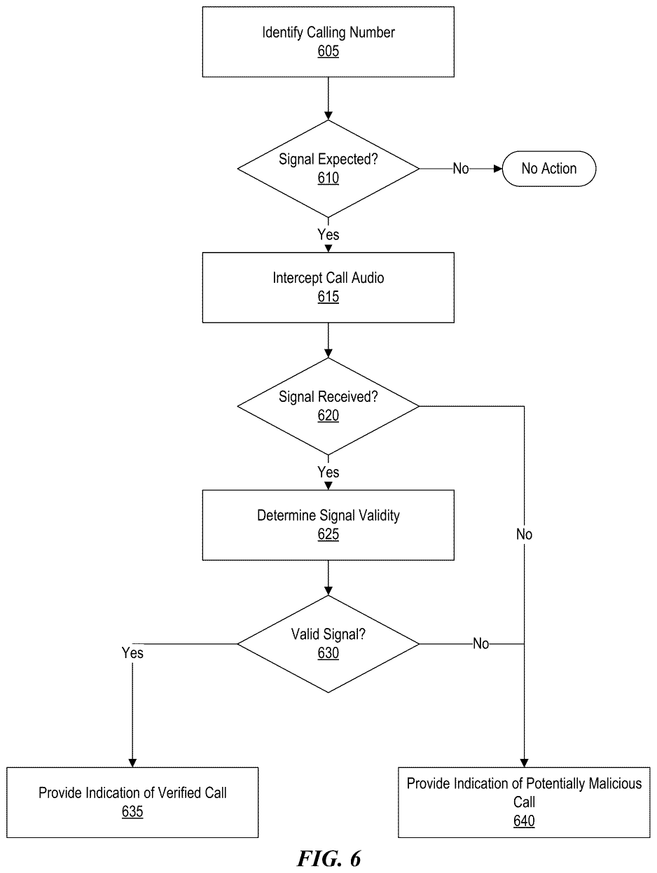

FIG. 6 is a flowchart that illustrates another example process for call verification according to some implementations. In FIG. 6, verification is done by a carrier rather than on a UE such as a smartphone. At operation 605, the carrier can identify a calling number. At operation 610, the carrier can determine if a signal is expected, for example based on the phone number. As an example, companies can register with a carrier and provide phone numbers to the carrier that the company uses for making outbound calls to customers, and the carrier can check the calling number against a database of known numbers to determine if a signal is expected. If no signal is expected, the process can stop. If a signal is expected, the carrier can intercept the call audio to identify a signal. Intercepting the call audio can have significant privacy implications. Thus, in some implementations, audio capture is limited to a brief period of time (e.g., 1 ms, 10 ms, 100 ms, 1 s, or any number between these numbers, or more or less), for example based on a length of a signal. In some implementations, the carrier additionally or alternatively only captures audio in a particular frequency range or ranges. For example, source identification signals can have frequencies outside the range of human hearing, and the carrier may only capture audio within the expected frequency range for a signal.

At operation 620, the carrier can determine if a signal was received by analyzing the captured audio. If not, the carrier can provide an indication of a potentially malicious call at operation 640, for example by sending a message or other indication to a receiving UE indicating that the call is potentially malicious. If a signal was received, the carrier can determine signal validity at operation 625, for example as described herein. At operation 630, if the signal is valid, the carrier can provide an indication of a verified caller at operation 635. If the signal could not be validated, the carrier can provide an indication that the call is potentially malicious at operation 640.

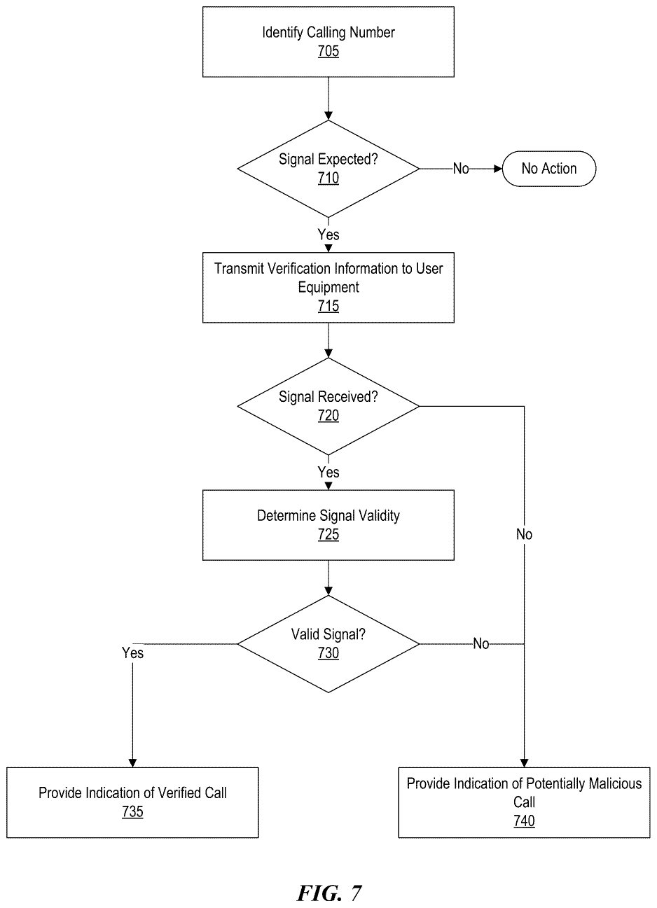

FIG. 7 is a flowchart that illustrates another example process for call verification according to some implementations. At operation 705, a system can identify a calling number. At operation 710, the system can determine if a source identification signal is expected for the number. If not, the system may take no further action and the call can continue without verification. If a source identification signal is expected, the system can, at operation 715, transmit verification information to a receiving user equipment device (UE). The verification information can include, for example, an indication that an expected source identification signal was not received, a received source identification signal, and/or any other information for verifying the caller. At operation 720, the UE can determine if a signal was received. If not, the UE can, at operation 740, provide an indication to a recipient (e.g., by displaying an alert on the UE) that the call is potentially malicious. If a source identification signal was received, the UE can, at operation 725, determine the validity of the source identification signal. The determination can be done by the UE itself, by the system that sent the verification information, or by another system. At operation 730, if the signal is invalid, the UE can provide an indication that the call is potentially malicious at operation 740. If the source identification signal is valid, the system can provide an indication to the user that the call is verified at operation 735.

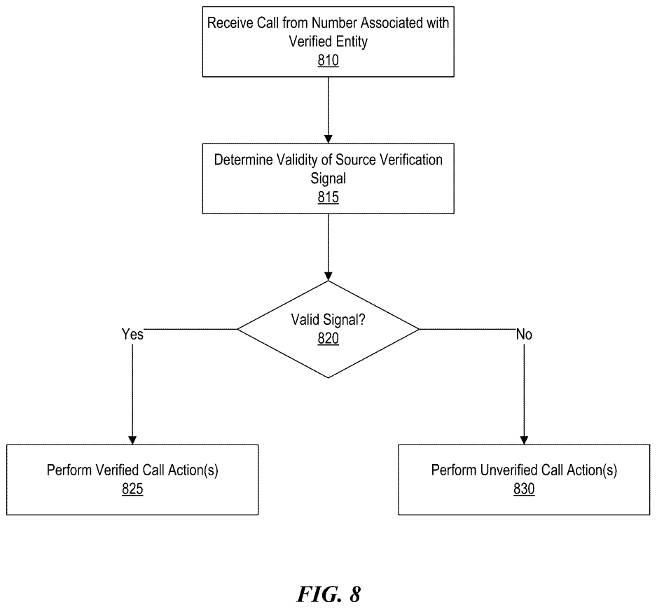

FIG. 8 is a flowchart that illustrates an example call verification process according to some implementations. At operation 810, a recipient can receive a call from a number associated with a verified entity such as a bank, telecommunications company, or utility company. At operation 815, a system (e.g., a system operating by the telecommunications company or the recipient's user equipment, such as a smartphone), can determine if a valid source identification signal has been received. At operation 820, if no valid signal has been received, the system can perform one or more unverified call actions at operation 830. The unverified call actions can include mitigation actions such as, for example, providing an alert to the recipient that the call is not verified, dropping the call, sending the call to voicemail, etc. If the source identification signal is valid at operation 820, the system can perform one or more verified call actions at operation 825. The verified call actions can include, for example, providing an indication to the recipient that the call is verified. In some implementations, no actions are taken when a valid signal is detected.

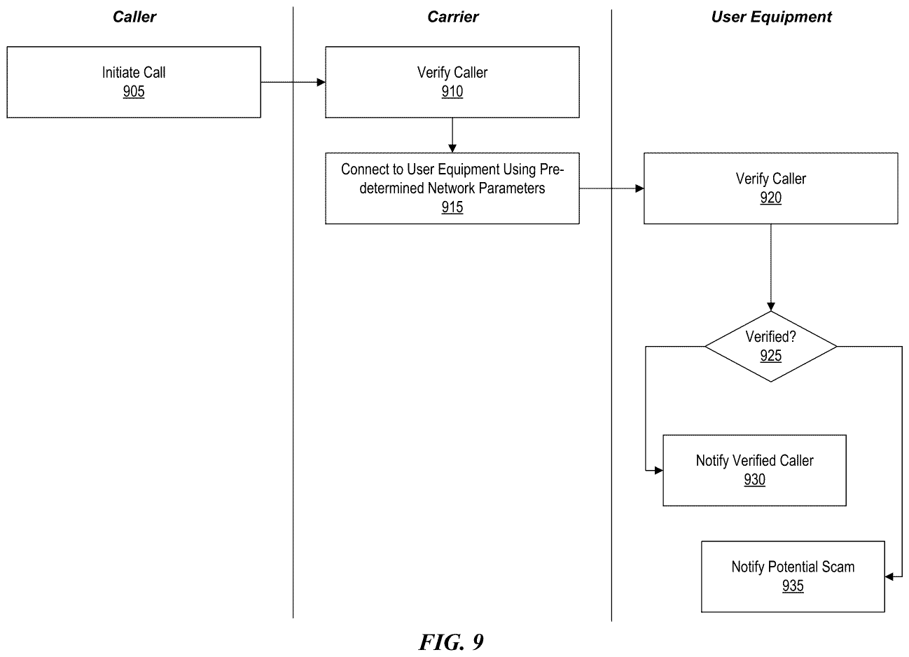

FIG. 9 illustrates another example call verification process according to some implementations. In FIG. 9, a multi-stage verification process is illustrated, and calls are carried using specific network parameters (e.g., specific bands, channels, time slots). At operation 905, a caller can initiate a call to a recipient. The carrier can verify the caller at operation 910, for example using a source identification signal or other verification approach. After verification, the carrier can connect the call to a user equipment (e.g., a smartphone) using predetermined network parameters. For example, based on the identity of the caller, the call can be carried using specific band(s), channel(s), and/or time slot(s). At operation 920, the UE can verify the caller. For example, the UE can consult a data store (either external or on-device) to determine that the call is connected using the expected pre-determined network parameters. In some implementations, verifying the caller also includes verifying a source identification signal, for example as described herein. At operation 925, the UE can determine if the call is verified. If so, the UE can provide an indication to the recipient that the call is verified at operation 930. If not, the UE can provide an indication that the call is not verified (e.g., that the call is a potential scam) at operation 935. In some implementations, multi-step verification is not carried out. In some implementations, source verification signals are not used and callers are verified by the UE based on the pre-determined network parameters. In some implementations,

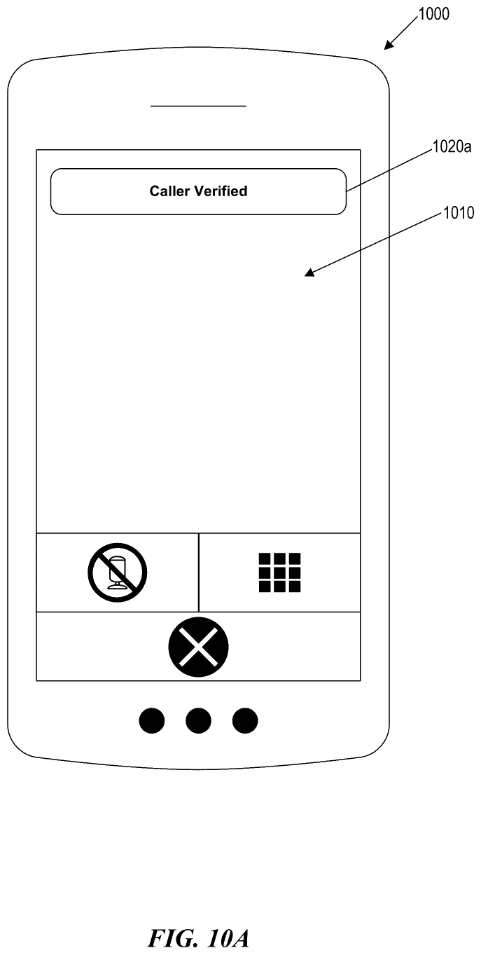

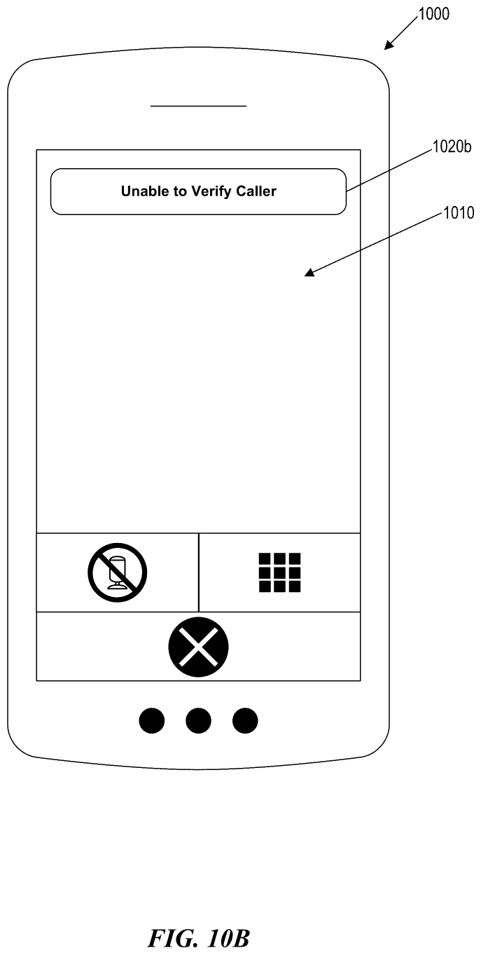

FIGS. 10A and 10B illustrate example alerts according to some implementations. In FIGS. 10A and 10B, a user device 1000 (e.g., a smartphone) includes a display 1010. When a call is received and a verification process is carried out, the user device 1000 can display an alert on the 1010. FIG. 10A illustrates an example in which a caller is verified (e.g., in which a source identification signal is determined to be valid). The user device 1000 displays an alert 1020a on the display 1010 indicating that the call is verified. In FIG. 10B, the call could not be verified (e.g., no source identification signal was received or an incorrect source identification signal was received). The user device 1000 can display an alert 1020b on the display 1010 indicating that the call is not verified.

### Computer System

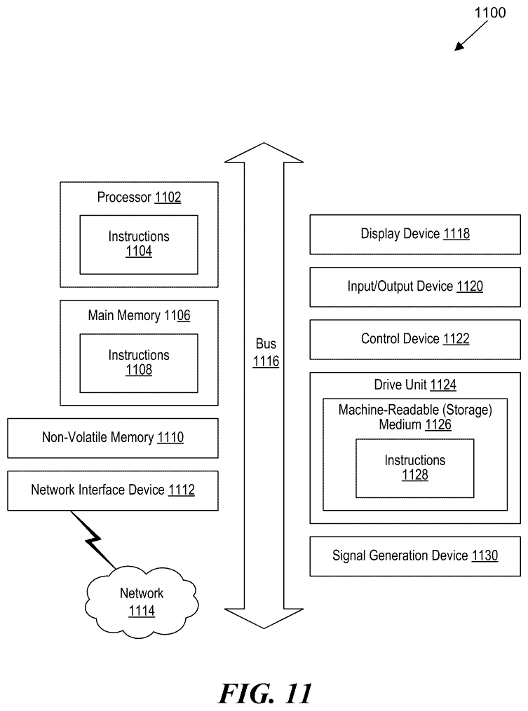

FIG. 11 is a block diagram that illustrates an example of a computer system 1100 in which at least some operations described herein can be implemented. As shown, the computer system 1100 can include: one or more processors 1102, main memory 1106, non-volatile memory 1110, a network interface device 1112, a video display device 1118, an input/output device 1120, a control device 1122 (e.g., keyboard and pointing device), a drive unit 1124 that includes a machine-readable (storage) medium 1126, and a signal generation device 1130 that are communicatively connected to a bus 1116. The bus 1116 represents one or more physical buses and/or point-to-point connections that are connected by appropriate bridges, adapters, or controllers. Various common components (e.g., cache memory) are omitted from FIG. 11 for brevity. Instead, the computer system 1100 is intended to illustrate a hardware device on which components illustrated or described relative to the examples of the figures and any other components described in this specification can be implemented.

The computer system 1100 can take any suitable physical form. For example, the computing system 1100 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1100. In some implementations, the computer system 1100 can be an embedded computer system, a system-on-chip (SOC), a single-board computer system (SBC), or a distributed system such as a mesh of computer systems, or it can include one or more cloud components in one or more networks. Where appropriate, one or more computer systems 1100 can perform operations in real time, in near real time, or in batch mode.

The network interface device 1112 enables the computing system 1100 to mediate data in a network 1114 with an entity that is external to the computing system 1100 through any communication protocol supported by the computing system 1100 and the external entity. Examples of the network interface device 1112 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1106, non-volatile memory 1110, machine-readable medium 1126) can be local, remote, or distributed. Although shown as a single medium, the machine-readable medium 1126 can include multiple media (e.g., a centralized/distributed database and/or associated caches and servers) that store one or more sets of instructions 1128. The machine-readable medium 1126 can include any medium that is capable of storing, encoding, or carrying a set of instructions for execution by the computing system 1100. The machine-readable medium 1126 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 1110, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1104, 1108, 1128) set at various times in various memory and storage devices in computing device(s). When read and executed by the processor 1102, the instruction(s) cause the computing system 1100 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for caller verification comprising:
receiving, by a user equipment (UE) associated with a recipient, a phone call from a caller,
wherein the phone call is received via a wireless telecommunications network;
determining a phone number of a caller associated with the phone call;
querying a caller verification database to determine when the phone number of the caller is associated with a verified caller; and
when the phone number is associated with a verified caller:
analyzing data of the call to determine whether the data of the call comprises a source identification signal, wherein the data of the call comprises audio data or another type of data;
when the source identification signal is present in the data of the call:
determining whether the source identification signal matches an expected signal;
when the source identification signal matches the expected signal, generating instructions to cause the UE to provide a first notification to the recipient indicating that the phone call is verified; and
when the source identification signal does not match the expected signal, generating instructions to cause the UE to provide a second notification to the recipient indicating that the phone call is not verified; and
when the source identification signal is not present in the data, generating instructions to cause the UE to provide a third notification to the recipient indicated that the phone call is not verified.

2. A method for caller verification comprising:
receiving, by a user equipment (UE) associated with a recipient, a phone call from a caller;
determining a phone number of the caller associated with the phone call;
determining that the phone number is associated with a verified caller;
when the phone number is associated with a verified caller:
identified a presence of a source identification signal;
when the source identification signal is present:
determining when the source identification signal matches an expected signal;
when the source identification signal matches the expected signal:
generating instructions to cause the UE to provide a first notification to the recipient indicating that the phone call is verified; and
when the source identification signal does not match the expected signal:
generating instructions to cause UE to provide a second notification to the recipient indicating that the phone call is not verified,
wherein the source identification signal comprises an audio signal and
wherein the source identification signal is generated based at least in part on one or more of: a phone number of the UE, a subset of the phone number of the UE, a current time of day, a current day of week, a current month, or a current year.

3. The method of claim 2, further comprising:
when the source identification signal is not present:
generating instructions to cause the UE to provide a third notification to the recipient indicating that the phone call is not verified.

4. The method of claim 2, wherein at least one of the first notification or the second notification comprises at least one of an audio notification or a visual notification, wherein the visual notification is shown to the recipient via a display of the UE.

5. The method of claim 2, wherein the source identification signal comprises an audio signal.

6. The method of claim 5, wherein the audio signal comprises frequencies of less than about 20 Hz, more than about 20 kHz, or less than about 20 Hz and more than about 20 kHz.

7. The method of claim 2, wherein the source identification signal is generated based at least in part on one or more of: a phone number of the UE, a subset of the phone number of the UE, a current time of day, a current day of week, a current month, or a current year.

8. The method of claim 2, wherein the source identification signal is generated based on a shared secret.

9. The method of claim 8, wherein determining if the source identification signal matches the expected signal comprises:
computing the expected signal based at least in part on the shared secret; and
comparing the expected signal to the received signal.

10. The method of claim 2, wherein determining when the source identification signal matches the expected signal comprises:
extracting the source identification signal;
accessing the expected signal in a data store stored in a memory of the UE, wherein the signal is accessed based at least in part the phone number; and
comparing the extracted source identification signal to the accessed expected signal.

11. The method of claim 2, wherein determining when the source identification signal matches the expected signal comprises:
extracting the source identification signal;
accessing the expected signal in a data store stored in an external server, wherein the signal is accessed based at least in part the phone number; and
comparing the extracted source identification signal to the accessed expected signal.

12. The method of claim 2, wherein determining when the source identification signal matches the expected signal comprises:
extracting the source identification signal;
transmitting the source identification signal to an external server; and
receiving, from the external server, an indication that the source identification signal matches the expected signal.

13. The method of claim 2, wherein the phone call is received via a wireless telecommunications network, wherein the wireless telecommunications network comprises a cellular telecommunications network or a non-terrestrial telecommunications network.

14. The method of claim 13, wherein the source verification signal comprises a wireless transmission configuration comprising one or more of: a pre-determined band, a pre-determined channel, or a pre-determined time slot,
wherein determining when the source identification signal matches the expected signal comprises comparing the wireless transmission configuration to an expected wireless transmission configuration associated with the phone number of the caller.

15. A method for caller verification comprising:
receiving, by a component of a wireless telecommunications network, a phone call from a caller directed to a recipient;
determining a phone number of the caller associated with the phone call;
determining that the phone number is associated with a verified caller;
when the phone number is associated with a verified caller:
identified a presence of a source identification signal;
when the source identification signal is present:
determining when the source identification signal matches an expected signal;
when the source identification signal matches the expected signal:
generating first instructions to cause a user equipment (UE) to provide a first notification to the recipient indicating that the phone call is verified; and
transmitting the first instructions to the UE; and
when the source identification signal does not match the expected signal:
performing at least one mitigation action.

16. The method of claim 15, wherein the at least one mitigation action comprises terminating the phone call.

17. The method of claim 15, wherein the least one mitigation action comprises:
generate second instructions to cause the UE to provide a second notification to the recipient indicating that the phone call is not verified; and
transmit the second instructions to the UE.

18. The method of claim 15, wherein the source identification signal comprises an audio signal.

19. The method of claim 15, wherein the source identification signal is generated based at least in part on one or more of: a phone number of the UE, a subset of the phone number of the UE, a current time of day, a current day of week, a current month, or a current year.

20. The method of claim 15, wherein the source identification signal is generated based on a shared secret.
